(19) United States
(12) Patent Application Publication
(10) Pub. No.: US 2020/0160228 A1
(43) Pub. Date: May 21, 2020

(54) COGNITIVE COMPUTING DEVICE FOR PREDICTING AN OPTIMAL STRATEGY IN COMPETITIVE CIRCUMSTANCES

(71) Applicant: International Business Machines Corporation, Armonk, NY (US)

(72) Inventors: Mahmoud Amin, Poughkeepsie, NY (US); Zhenxing Bi, Niskayuna, NY (US); Lawrence A. Clevenger, Saratoga Springs, NY (US); Leigh Anne H. Clevenger, Rhinebeck, NY (US); Krishna R. Tunga, Wappingers Falls, NY (US)

(21) Appl. No.: 16/191,894

(22) Filed: Nov. 15, 2018

(51) Int. Cl. G06N 99/00

(52) U.S. Cl. CPC G06N 99/005

(57) ABSTRACT

Embodiments of the invention provide a computer-implemented method of generating individualized strategies for a group of team members pursing a team objective based on an optimized team strategy. A team objective and a plurality of inputs associated with a plurality of team members is received at a strategy engine. A training model is applied to the plurality of inputs from the first plurality of team members to generate a plurality of individualized strategies for the first plurality of team members to achieve the team objective. An optimized team strategy based on the plurality of individualized strategies is generated and the individualized strategies are communicated to each team member wherein each team member pursuing their individualized strategy leads to achieving the team objective.

### BACKGROUND

The invention relates generally to computing devices and, more particularly, relates to computing systems, computer-implemented methods, and computer program products configured to cognitively predict an optimal strategy in competitive circumstances.

Mobile computing devices are hand-held devices that have the hardware, software, and battery power required to execute typical desktop and web-based applications. Mobile computing devices have similar hardware and software components as those used in personal computers (PCs), such as processors, random memory and storage, Wi-Fi, and a base operating system (OS). However, they differ from PCs in that they are built specifically for mobile architectures and to enable portability. Among the common examples of mobile computing devices include tablet PCs, personal digital assistants (PDAs), laptops, smartwatches, or smartphones, each of which includes a built-in processor, memory and OS that are capable of executing a wide variety of computer software application programs. Because of their mobility, mobile computing devices make computing power and connectivity available to users in virtually any environment.

### SUMMARY

According to a non-limiting embodiment, a computer-implemented method for generating a team strategy to achieve a team objective is provided. The method includes using a processor for receiving a team objective and a plurality of inputs associated with a first plurality of team members and applying, via the processor, a training model to the plurality of inputs from the first plurality of team members. The method also includes using the processor for generating a plurality of individualized strategies for the first plurality of team members to achieve the team objective and for generating an optimized team strategy based on the plurality of individualized strategies. The method then includes using the processor for communicating an individualized strategy to each team member of the first plurality of team members, wherein each team pursuing their individualized strategy leads to achieving the team objective.

According to another non-limiting embodiment, a system for optimizing a team strategy is provided. The system includes a processor communicatively coupled to a memory unit, wherein the processor is configured to execute program instructions that cause the processor to receive a team objective and a plurality of inputs associated with a first plurality of team members and apply a training model to the plurality of inputs from the first plurality of team members. The program instructions also cause the processor to generate a plurality of individualized strategies for the first plurality of team members to achieve the team objective and generate an optimized team strategy based on the plurality of individualized strategies. The program instructions also cause the processor to communicate an individualized strategy to each team member of the first plurality of team members, wherein each team pursuing their individualized strategy leads to achieving the team objective.

According to yet another non-limiting embodiment, a computer program product is provided. The computer program product includes a computer readable storage medium having program instructions embodied therewith, the program instructions executable by a computer processor to cause the computer processor to perform a method for optimizing a team strategy. The method includes receiving a team objective and a plurality of inputs associated with a first plurality of team members and applying a learning model to the plurality of inputs from the first plurality of team members. The method also includes generating a plurality of individualized strategies for the first plurality of team members to achieve the team objective and generating an optimized team strategy based on the plurality of individualized strategies. The method also includes communicating an individualized strategy to each team member of the first plurality of team members, wherein each team pursuing their individualized strategy leads to achieving the team objective.

Additional features and advantages are realized through the techniques of the invention. Other embodiments and aspects of the invention are described in detail herein and are considered a part of the claimed invention. For a better understanding of the invention with the advantages and the features, refer to the description and to the drawings.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings, in which

FIG. 1 depicts a cloud computing environment according to one or more embodiments of the present invention; and

FIG. 2 depicts abstraction model layers of a cloud computer environment according to one or more embodiments of the present invention;

FIG. 3 depicts a block diagram illustrating an exemplary computer processing system that may be utilized to implement one or more embodiments of the present invention;

FIG. 4 depicts a block diagram illustrating sensors collecting and providing inputs to a locally assembled station/server in communication with the cloud computing environment according to one or more embodiments of the present invention;

FIG. 5 depicts a block diagram illustrating inputs received via wearable electronic devices and cognitive computing performed in the cloud computing environment accessing other database and online resources according to one or more embodiments of the present invention; and

FIG. 6 is a flow diagram illustrating a method for generating a team strategy to achieve a team objective according to one or more embodiments of the present invention.

The diagrams depicted herein are illustrative. There can be many variations to the diagram or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

In the accompanying figures and following detailed description of the disclosed embodiments, the various elements illustrated in the figures are provided with two or three digit reference numbers. With minor exceptions, the leftmost digit(s) of each reference number correspond to the figure in which its element is first illustrated.

### DETAILED DESCRIPTION

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computer systems and specific computer programs to implement the various technical features described herein are well known. Accordingly, in the interest of brevity, many conventional implementation details are only mentioned briefly herein or are omitted entirely without providing the well-known system and/or process details.

The present invention may be implemented in one or more embodiments using cloud computing. Nonetheless, it is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

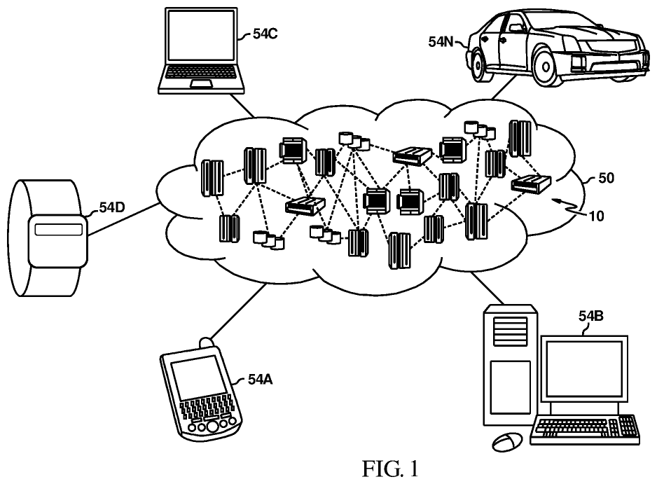

Referring now to FIG. 1, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, wearable electronic device 54D, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-54N shown in FIG. 1 are intended to be illustrative only and that computing nodes 10 and cloud computing environment 50 can communicate with any type of computerized device over any type of network and/or network addressable connection (e.g., using a web browser).

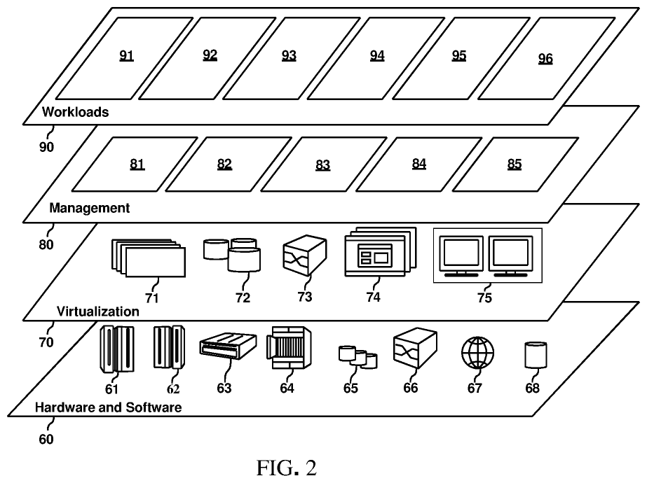

Referring now to FIG. 2, a set of functional abstraction layers provided by cloud computing environment 50 is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73; including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and learning model processing 96, for performing one or more processes for generating, revising, updating and communicating the team strategy and the individualized strategies for achieving the team objective described herein.

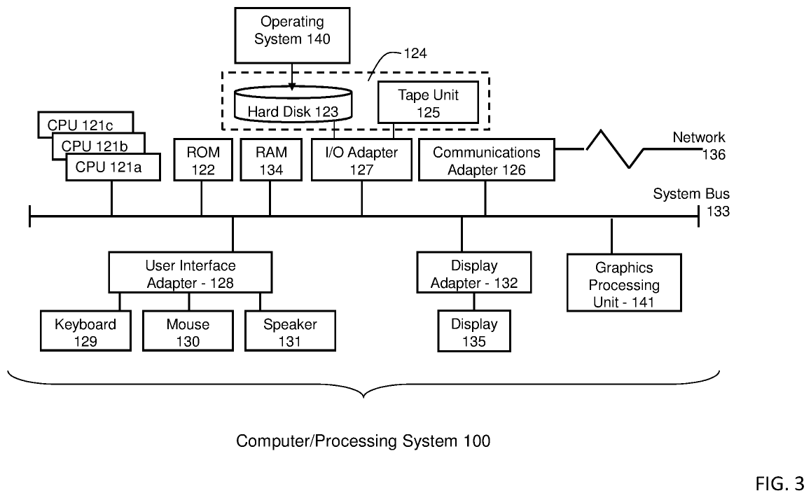

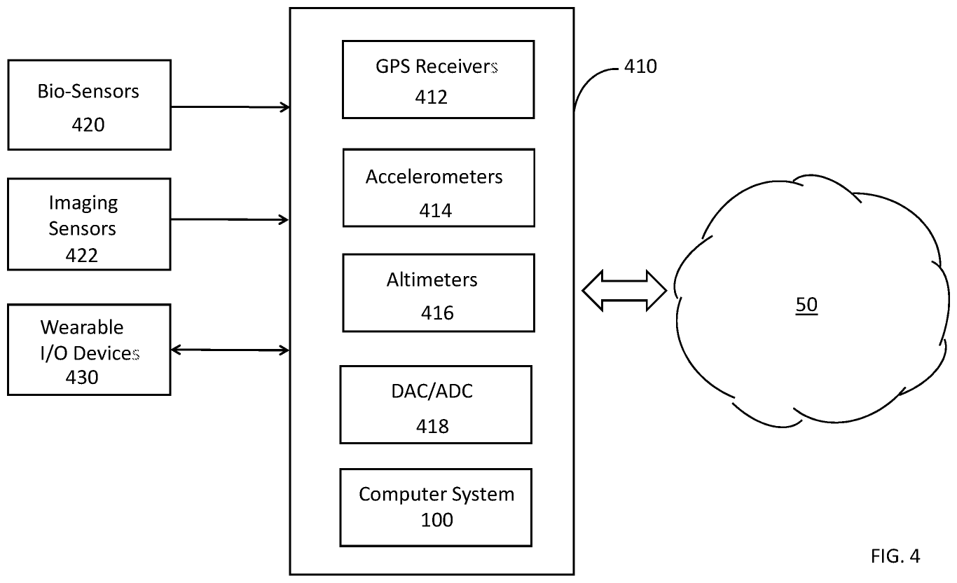

Referring to FIG. 3, there is shown an embodiment of a processing system, commonly referred to as a computer system 100, which may be configured as a locally assembled station/server 410 (FIG. 4) for communication with various sensors including wearable devices, and which communicates over a communications network to one or more nodes 10 of the cloud computing environment 50 for implementing the teachings herein. The computer system 100 has one or more central processing units (processors) 121a, 121b, 121c, etc. (collectively or generically referred to as processor(s) 121). In one or more embodiments, each processor 121 may include a reduced instruction set computer (RISC) microprocessor. Processors 121 are coupled to system memory (RAM) 134 and various other components via a system bus 133. Read only memory (ROM) 122 is coupled to the system bus 133 and may include a basic input/output system (BIOS), which controls certain basic functions of computer system 100.

FIG. 3 further depicts an input/output (I/O) adapter 127 and a network adapter 126 coupled to the system bus 133. I/O adapter 127 may be a small computer system interface (SCSI) adapter that communicates with a hard disk 123 and/or tape storage drive 125 or any other similar component. I/O adapter 127, hard disk 123, and tape storage device 125 are collectively referred to herein as mass storage 124.

Operating system 140 for execution on the processing system 100 may be stored in mass storage 124. However, the operating system 140 may also be stored in RAM 134 of the computer system 100. Operating systems according to embodiments of the present invention include, for example, UNIX™, Linux™, Microsoft XP™, AIX™, and IBM's i5/OS™.

A network adapter 126 interconnects bus 133 with an outside network 136 enabling the computer system 100 to communicate with other such systems. A screen (e.g., a display monitor) 135 is connected to system bus 133 by display adaptor 132, which may include a graphics adapter to improve the performance of graphics intensive applications and a video controller. In one embodiment, adapters 127, 126, and 132 may be connected to one or more I/O busses that are connected to system bus 133 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 133 via user interface adapter 128 and display adapter 132. A keyboard 129, mouse 130, and speaker 131 all interconnected to bus 133 via user interface adapter 128, which may include, for example, a Super I/O chip integrating multiple device adapters into a single integrated circuit.

In exemplary embodiments, the computer system 100 includes a graphics processing unit 141. Graphics processing unit 141 is a specialized electronic circuit designed to manipulate and alter memory to accelerate the creation of images in a frame buffer intended for output to a display. In general, graphics processing unit 141 is very efficient at manipulating computer graphics and image processing and has a highly parallel structure that makes it more effective than general-purpose CPUs for algorithms where processing of large blocks of data is done in parallel.

Thus, as configured in FIG. 3, the computer system 100 includes processing capability in the form of processors 121, storage capability including RAM 134 and mass storage 124, input means such as keyboard 129 and mouse 130, and output capability including speaker 131 and display 135. In one embodiment, a portion of RAM 134 and mass storage 124 collectively store the operating system to coordinate the functions of the various components shown in FIG. 3.

In FIG. 4 the locally assembled station/server 410 may embody the computer system 100 (shown in FIG. 3) and may also include one or more components or modules such as a GPS receiver 412, accelerometers 414, altimeters 416, and digital-to-analog and analog-to-digital converters 418. Input from sensors such as, but not limited to, bio-sensors 420 and imaging sensors 422 is received at the base station/server 410 and are accessed by one or more of the components or modules of the base station/server 410. In one or more embodiments, some or all of the inputs are then communicated to the cloud computing environment 50 for processing.

For example, input from the bio-sensors 420 may include one or more team members' body temperature or heart rate which is then received at the locally assembled station/server 410. The base station/server 410 may then process the inputs or communicate the inputs to the cloud computing environment 50. Also, the image sensors 422 may take a video or image of one or more team members which may be compressed by the base station/server 410 in order to then communicate the compressed video or image to the cloud computing environment 50.

Sensors may also provide input such that the GPS receiver 412, the accelerometers 414, or the altimeters 416 provide the location, altitude and heading of one or more team members to the cloud computing environment 50. In one or more embodiments, the sensors 420, 422 provide input directly to the cloud computing environment 50. Wearable devices 430 and input/output devices may also convey personal metrics to the base station/server 410 or directly to the cloud computing environment 50. The wearable devices 430 may also display or indicate the team objective for a group of team members and then receive and display a team strategy to be pursued by the team members in order to achieve the team objective. Also, the team strategy may require the team members to pursue individualized strategies. The combination of each team member pursuing his/her own individualized strategy leads to the team as a whole pursuing their team strategy and, thus, achieve their team objective.

However, while each team member pursues his/her own individualized strategy while the team as a whole is pursuing the team objective, one or more individualized strategy may be updated or revised based on the personal metrics or other inputs received by the base station/server 410 or received by the cloud computing environment 50. In the event one or more of the individualized strategies are updated or revised, the team strategy may then be updated or revised. Team and individualized strategies may be communicated to the team members via the wearable devices 430 or other devices such as a mobile telephone or a personal digital assistant over communication networks such as a cellular network. Also, one or more of the wearable devices 430 may include one or more of the sensors 420, 422 or other sensors such as, for example, a GPS sensor, image sensor, and/or a device for collecting humidity, temperature, wind or other environmental conditions relevant to the individualized or team strategies.

More than one team may provide input via, for example, the sensors 420, 430 and wearable devices 430 to the base station/server 410 and/or to the cloud computing environment 50. In such case, a second group of team members could have their own team objective and their own team strategy consisting of individualized strategies for each of the team members of the second group of team members. Also, one or more members of one team may receive one or more inputs such as personal metrics as well as position and heading from one or more members of another team. In such case, a team strategy and individualized strategies of one team can be based on and revised as a result of inputs from members of another team.

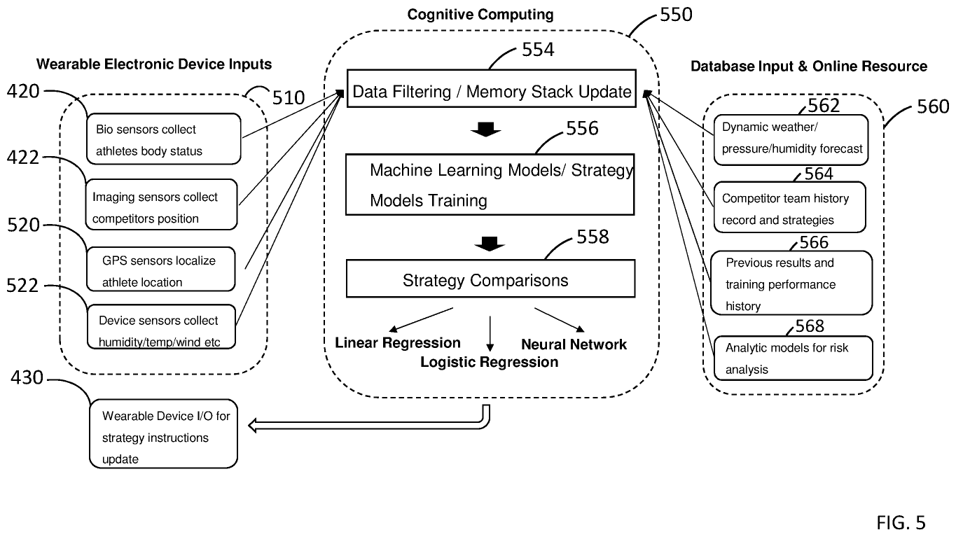

FIG. 5 depicts wearable electronic devices 430 providing inputs 510 to the cloud computing environment 50 for performing cognitive computing 550. As shown in FIG. 5, the inputs 510 can include, for example, the athletes' personal metrics as determined from the bio-sensors 420, the positions of other competitors as indicated by the image sensors 422, localization of the athletes determined from GPS sensors 520, and collected humidity/temperature/wind speed and direction collected from other device sensors 522. These inputs are provided to the base station/server 410 and then to the cloud computing environment 550 along with other inputs available from databases and online resources 560.

Cognitive computing 550 is performed by accessing various databases and online resources 560 for additional inputs such as dynamic weather/pressure/humidity forecasts 562, competitor team history records and strategies 564, previous results and training performance histories 566, and analytic models 568 for risk analysis. The data from the databases and online resources 560 may be publicly available information as well as information entered and stored by members of one or more teams. For example, competitor team histories and strategies 564 can be recorded as a result of previous competitions by event organizers or by the team members that had participated in past competitions. Also, a team's previous results and training performance histories 566 can be collected and stored during and after each training session. Analytic models 568 for risk analysis may perform a review of the risks associated with a particular event or generated a strategy such as a team strategy or personalized individual strategies.

The cognitive computing 550 process includes filtering the device inputs 510 and the database and online resources 560 and then updating variables of the memory stack as depicted in block 554. The filtered data and memory stack variables are then provided to a machine learning model 556 for generating one or more team strategies according to or based on a team objective submitted or entered via the base station/server 410 or via the wearable device 430 by the members of a particular team.

The machine learning model 556 is trained using pre-existing or known data/inputs and outcomes or results wherein the outcomes or results are previous or historical team strategies and individualized strategies. Using analytic capabilities and techniques, the learning model 556 establishes relationships between the inputs and the results. Once deemed accurate based on the historical data and corresponding outcomes, the learning model 556 is then applied to new inputs 510, 560 to predict automated outcomes/results. In other words, based on current inputs 510, 560, one or more team strategies and corresponding individualized strategies for achieving a current team objected are determined. Particular individualized strategies are pursued by each team member of a team in order to accomplish a team objective pursuant to a particular team strategy. As shown in block 558, multiple team strategies may be compared with one another in order to determine the optimal team strategy based on current inputs and conditions. The team strategy comparisons may be based on statistical model comparisons such as linear regression, logistical regression and artificial neural network technologies. The team strategy and individualized strategies may be updated or revised based on feedback received as inputs to the machine learning model 556 while currently pursuing a team objective. The individualized and team strategies as well as updates can be communicated to computing devices 54A-54N such as wearable devices 430 as shown in FIG. 5.

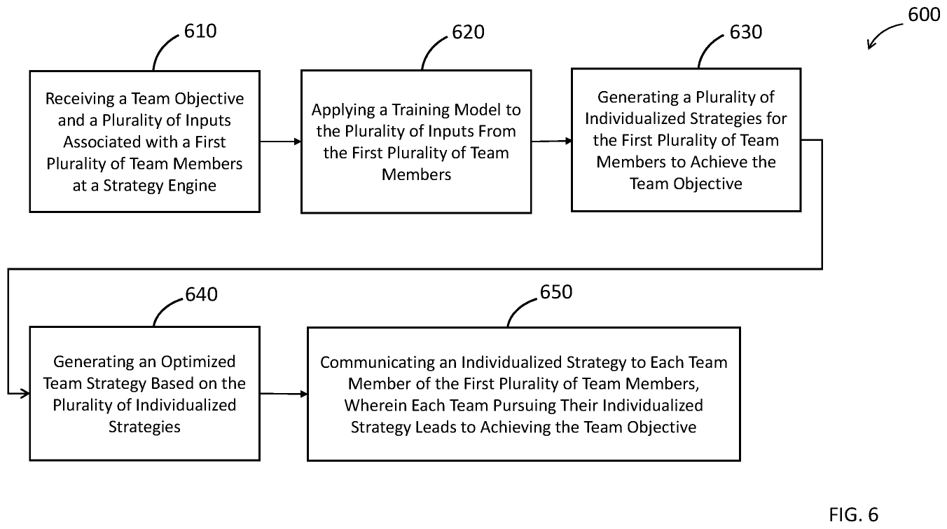

Turning to FIG. 6, one or more embodiments may include a method 600 for generating a team strategy to achieve a team objective. The flow diagram of FIG. 6 illustrates the method 600 that includes process block 610 for receiving a team objective and a plurality of inputs associated with a first plurality of team members and process block 620 for applying a training model to the plurality of inputs from the first plurality of team members. The method 600 also includes process block 630 for generating a plurality of individualized strategies for the first plurality of team members to achieve the team objective and process block 640 for generating an optimized team strategy based on the plurality of individualized strategies. The method 600 then includes process block 650 for communicating an individualized strategy to each team member of the first plurality of team members, wherein each team pursuing their individualized strategy leads to achieving the team objective.

In one or more embodiments, a team can achieve a common goal by optimizing strategies, for example, on energy consumption, resource sharing, decision making and accident rescue. An individual team member's body status or personal matrix can be collected by bio-sensors and transferred to the base station/server 410 for monitoring. Also, an individual team member's location information can be collected through the GPS receiver and the team member's location can be dynamically updated through the base station/server 410 via a network such as, for example, the Internet or a cellular network. An individual team member's energy consumption information such as, for example, food, battery, gears and medicine could be input through the wearable device and dynamic weather reports and forecasting can be provided by the online resources to the base station/server 410. The base/station server 410 accesses the cloud computing environment 50 to conduct cloud computing with the above-identified input from team members and to generate an optimized plan for each individual team member regarding energy preservation, route selection such as hiking and path selection, following strategy, camping or overnight decisions, and risk analysis. In one or more embodiments, when an individual team member is about to run out of food, gear, or power, for example, the base station/server 410 forecasts the risk in advance and sends instructions to at least one other team member, such as the closest team member, for assistance. The instructions for assistance may be sent to all other team members. The team and individual strategies may then be updated based on real-time inputs from all team members and dynamic weather conditions. Also, historic data associated with each team member may be saved in the base station/server 410 or in the cloud computing environment 50 for data analysis and for strategy generation, comparison and evaluation.

The method 600 may also further include revising one or more of the individualized strategies while the first plurality of team members is pursuing the team objective and updating the team strategy in response to revising one or more of the individual strategies. The method 600 may also further include receiving a plurality of inputs from a second plurality of team members and applying the learning model to the plurality of inputs from the second plurality of team members wherein the generated plurality of individualized strategies for the first plurality of team members is based on the plurality of inputs from the second plurality of team members in order for the first plurality of team members to achieve their team objective.

Various technical benefits are achieved using the system and methods described herein, including the capability of providing enhanced performance for applications with exclusive access to the co-processors while also allowing applications that do not need performance access to accelerators when shared access is available. In this manner, the computing device can realize performance gains through the use of co-processors in the system, thereby improving overall processing speeds.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for generating a team strategy to achieve a team objective, the method comprising:
receiving, using a processor, a team objective and a plurality of inputs associated with a first plurality of team members;
applying, using the processor, a training model to the plurality of inputs from the first plurality of team members;
generating, using the processor, a plurality of individualized strategies for the first plurality of team members to achieve the team objective;
generating, using the processor, an optimized team strategy based on the plurality of individualized strategies; and
communicating, using the processor, an individualized strategy to each team member of the first plurality of team members, wherein each team pursuing their individualized strategy leads to achieving the team objective.

2. The computer-implemented method of claim 1 further comprising revising one or more of the individualized strategies while the first plurality of team members is pursuing the team objective.

3. The computer-implemented method of claim 2 further comprising updating the team strategy in response to revising one or more of the individual strategies.

4. The computer-implemented method of claim 1 further comprising receiving a plurality of inputs from a second plurality of team members.

5. The computer-implemented method of claim 4 further comprising applying the training model to the plurality of inputs from the second plurality of team members and wherein the generated plurality of individualized strategies for the first plurality of team members is based on the plurality of inputs from the second plurality of team members in order for the first plurality of team members to achieve the team objective.

6. The computer-implemented method of claim 1 wherein the training model accesses a plurality of individualized strategies of team members pursuing a past team objective.

7. The computer-implemented method of claim 1 further comprising communicating the optimized team strategy to the plurality of first team members.

8. The computer-implemented method of claim 1 wherein the individualized strategies are customized based on a current personal matrix of each of the team members of the first plurality of team members.

9. The computer-implemented method of claim 1 wherein the training model has been trained with historical inputs from the plurality of team members.

10. The computer-implemented method of claim 1 further comprising inputting the optimized team strategy and the plurality of individualized strategies of the plurality of first team members into the learning model as historical input data.

11. A system for optimizing a team strategy, the system comprising:
a processor communicatively coupled to a memory unit, wherein the processor is configured to execute program instructions that cause the processor to:
receive a team objective and a plurality of inputs associated with a first plurality of team members;
apply a training model to the plurality of inputs from the first plurality of team members;
generate a plurality of individualized strategies for the first plurality of team members to achieve the team objective;
generate an optimized team strategy based on the plurality of individualized strategies; and
communicate an individualized strategy to each team member of the first plurality of team members, wherein each team pursuing their individualized strategy leads to achieving the team objective.

12. The system of claim 11, wherein the program instructions further cause the processor to revise one or more of the individualized strategies while the first plurality of team members is pursuing the team objective.

13. The system of claim 11, wherein the program instructions further cause the processor to update the team strategy in response to revising one or more of the individual strategies.

14. The system of claim 11, wherein the program instructions further cause the processor to receive a plurality of inputs from a second plurality of team members.

15. The system of claim 14, wherein the program instructions further cause the processor to apply the training model to the plurality of inputs from the second plurality of team members and wherein the generated plurality of individualized strategies for the first plurality of team members is based on the plurality of inputs from the second plurality of team members in order for the first plurality of team members to achieve the team objective.

16. A computer program product comprising a computer readable storage medium having program instructions embodied therewith, the program instructions executable by a computer processor to cause the computer processor to perform a method for optimizing a team strategy, the method comprising:
receiving a team objective and a plurality of inputs associated with a first plurality of team members;
applying a training model to the plurality of inputs from the first plurality of team members;
generating a plurality of individualized strategies for the first plurality of team members to achieve the team objective;
generating an optimized team strategy based on the plurality of individualized strategies; and
communicating an individualized strategy to each team member of the first plurality of team members, wherein each team pursuing their individualized strategy leads to achieving the team objective.

17. The computer program product of claim 16, wherein the method performed by the computer processor further comprises revising one or more of the individualized strategies while the first plurality of team members is pursuing the team objective.

18. The computer program product of claim 16, wherein the method performed by the computer processor further comprises updating the team strategy in response to revising one or more of the individual strategies.

19. The computer program product of claim 16, wherein the method performed by the computer processor further comprises receiving a plurality of inputs from a second plurality of team members.

20. The computer program product of claim 16, wherein the method performed by the computer processor further comprises applying the training model to the plurality of inputs from the second plurality of team members and wherein the generated plurality of individualized strategies for the first plurality of team members is based on the plurality of inputs from the second plurality of team members in order for the first plurality of team members to achieve the team objective.
